(19) United States
(12) Patent Application Publication
(10) Pub. No.: US 2012/0002651 A1
(43) Pub. Date: Jan. 5, 2012

(54) Mobile Internet Access Point For Wireless LAN Terminals

(75) Inventors: Young-Ki Yoon, Seoul (KR); Jung-Goo Lee, Daejeon (KR); Doo-Ik Seok, Gwacheon Si (KR); Gi-Woong Kim, Gwonseon-gu (KR); Eun-Hae Bae, Giheung-gu (KR); Jae-Woong Baik, Yeongtong-gu (KR); Hyoung-Kwon Kim, Suji-gu (KR); Jong-Sun Lim, Seoul (KR); Byung-Joo Kim, Seoul (KR); Hyo-Joung Kim, Jungwon-gu (KR)

(73) Assignee: SK TELESYS., CO. LTD, Seoul (KR)

(21) Appl. No.: 13/172,691

(22) Filed: Jun. 29, 2011

(30) Foreign Application Priority Data
Jul. 5, 2010 (KR) 10-2010-0064169

(51) Int. Cl. H04W 88/08

(52) U.S. Cl. 370/338

(57) ABSTRACT

A mobile Internet access point is disclosed that connects a wireless LAN terminal to a mobile Internet. The mobile Internet access point includes: a plurality of mobile Internet access units, a wireless LAN access unit, and a converting unit. The mobile Internet access units communicate with one or more base stations, respectively, and are connected to a mobile Internet. The wireless LAN access unit is connected to one or more wireless LAN terminals that can be connected to a wireless LAN and manages connected wireless LAN terminals. The converting unit converts wireless data, received by the wireless LAN access unit, into mobile Internet data following the protocol of the mobile Internet. The converting unit also converts mobile Internet data, received via the plurality of mobile Internet access units, into wireless LAN data following the protocol of the wireless LAN. Therefore, although one of the mobile Internet access units does not work, the remaining mobile Internet access units can continue communicating with the base stations, thereby providing services to the wireless LAN terminal without interruption.

### BACKGROUND OF THE INVENTION

1. Field of the Invention

The present invention relates to wireless network systems, and more particularly, to a mobile Internet access point that connects a wireless LAN terminal to a mobile Internet.

2. Description of the Related Art

People can easily acquire and share information with others via the Internet irrespective of their location. A number of wired internet users have changed their wired internet service to a wireless internet service. In light of this, wireless Internet systems have been developed to provide a better quality service to the wireless internet users. This has led to an increase in the number of wireless Internet subscribers. In recent years, wireless Internet has been developed based on IEEE 802.11n standard and provided services at a speed similar to that of wired Internet.

Recent wireless communication technology has developed to allow portable computers to access a wireless LAN. Examples of the portable computers are a lap top computer, smart phones, etc. a mobile Internet access point that can prevent a wireless LAN terminal from being disconnected with the Internet or can avoid lowering the speed of services of the wireless LAN terminal, when the wireless LAN terminal accesses the Internet via a mobile Internet service.

In accordance with an exemplary embodiment of the present invention, there is provided a mobile Internet access point for a wireless LAN terminal, including: a plurality of mobile Internet access units that communicate with one or more base stations, respectively, and connected to a mobile Internet; a wireless LAN access unit, connected to one or more wireless LAN terminals that can be connected to a wireless LAN, for managing one or more connected wireless LAN terminals; and a converting unit for converting wireless data, received by the wireless LAN access unit, into mobile Internet data following the protocol of the mobile Internet and mobile Internet data, received via the plurality of mobile Internet access units, into wireless LAN data following the protocol of the wireless LAN.

Preferably, one of the plurality of mobile Internet access units scans the base stations and communicates with a base station transmitting the highest intensity signal. In addition, another of the plurality of mobile Internet access units communicates with one of the remaining base stations except for the base station that is communicating with the one mobile Internet access unit.

Preferably, the mobile Internet access point may further include: a controller for setting modes of communication between the plurality of mobile Internet access units and the base stations. The modes are to set connections between the plurality of mobile Internet access units and the base stations, respectively.

Preferably, the modes include a mode that is set by a user to communicate the plurality of mobile Internet access units with one or more base stations.

Preferably, the wireless LAN terminal includes a Wi-Fi module.

Preferably, if the one of the plurality of mobile Internet access units has a level of weak signal less than a preset value from the base station connected thereto, the mobile Internet access point scans the remaining base stations so that the mobile Internet access unit receiving the weak signal can be connected to a corresponding base station.

Preferably, the plurality of mobile Internet access units are one of the WiMAX, CDMA and WCDMA modems.

### BRIEF DESCRIPTION OF THE DRAWINGS

The features and advantages of the present invention will become more apparent from the following detailed description in conjunction with the accompanying drawings, in which:

FIG. 1 is a schematic block diagram illustrating a mobile Internet access point for a wireless LAN terminal, according to an embodiment of the present invention;

FIG. 2 is a view that describes communication between a base station and a mobile Internet access unit of a mobile Internet access point for a wireless LAN terminal, according to an embodiment of the present invention; and

FIG. 3 is a view that describes communication between a base station and a mobile Internet access unit of a mobile Internet access point for a wireless LAN terminal, according to another embodiment of the present invention.

### BRIEF DESCRIPTION OF SYMBOLS IN THE DRAWINGS

100: mobile Internet access point
110: mobile Internet access unit
110a: 1^{st} mobile Internet access unit
110b: 2^{nd} mobile Internet access unit
120: wireless LAN access unit
140: controller
200: wireless LAN terminal
300: base station
300a: 1^{st} base station
300c: 3^{rd} base station

### DETAILED DESCRIPTION OF SPECIFIC EMBODIMENTS

Hereinafter, exemplary embodiments of the present invention are described in detail with reference to the accompanying drawings. Detailed descriptions of well-known functions and structures incorporated herein may be omitted to avoid obscuring the subject matter of the present invention.

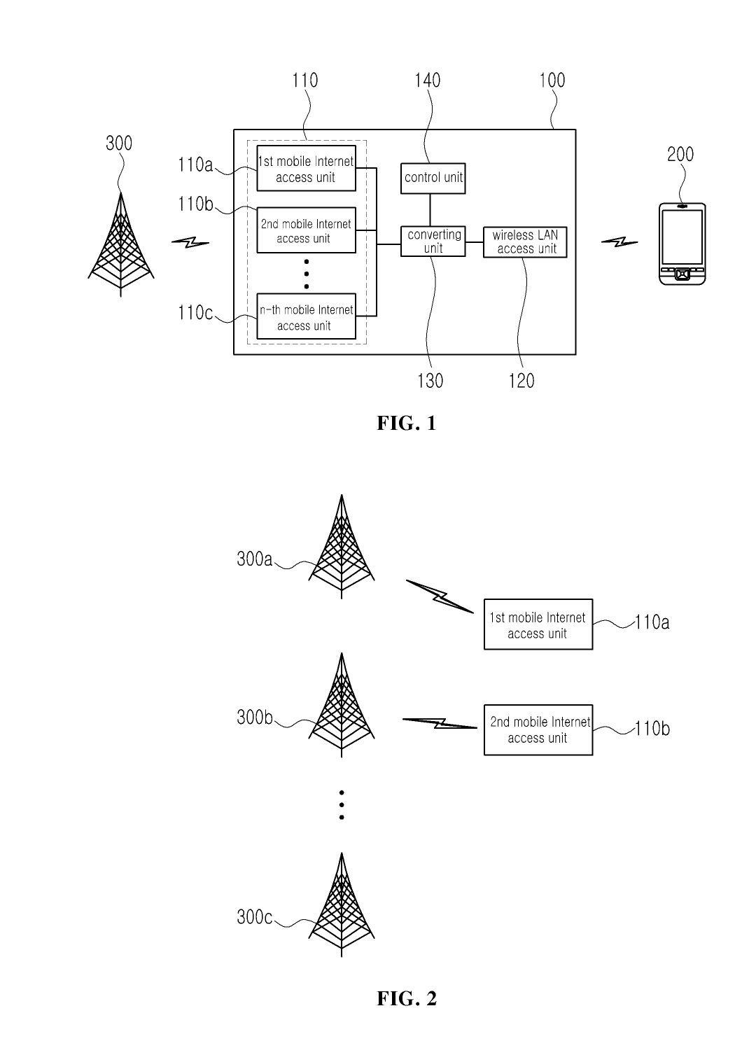

FIG. 1 is a schematic block diagram illustrating a mobile Internet access point for a wireless LAN terminal, according to an embodiment of the present invention.

As shown in FIG. 1, the mobile Internet access point 100 of a wireless LAN terminal 200 includes a mobile Internet access unit 110, a wireless LAN access unit 120, a converting unit 130 and a controller 140.

The mobile Internet access unit 110 communicates with a base station 300 in order to be connected to a mobile Internet provider. To this end, the base station 300 allocates a mobile IP to the mobile Internet access unit 110. The mobile Internet access unit 110 performs data communication with the base station 300. In an embodiment of the present invention, the data communication is conducted based on the WiBro standard.

Although the embodiment of the present invention is implemented in such a way that the mobile Internet access unit 110 can access the Internet via a mobile communication network, based on the WiBro standard, it should be understood that the present invention is not limited to the embodiment. For example, the embodiment can be modified in such a way that the mobile Internet access unit 110 accesses the Internet based on 2^{nd} or 3^{rd} generation communication standards, for example, CDMA and WCDMA.

In addition, the embodiment may be implemented in such a way to be operated in a combination of communication standards. In that case, the mobile Internet access unit 110 maybe configured to include a WiBro modem and a CDMA/WCDMA modem. Furthermore, the mobile Internet access unit 110 may be implemented in such a way that one of the WiBro modem, the CDMA modem and the WCDMA modem is installed and then it is replaced with another of the remaining modems as the occasion demands. In that case, the mobile Internet access point 100 can be configured with a mobile Internet access unit with a modem that can be best operated via signals which provide the best service according to the local service areas. For example, if a local area allows systems to be connected to the mobile Internet by performing WiBro communication, the mobile Internet access point 100 can be configured with a mobile Internet access unit with a WiBro modem. Likewise, if a local area allows systems to be connected to the mobile Internet by performing 2^{nd} or 3^{rd} generation communication, the mobile Internet access point 100 can be configured with a mobile Internet access unit with a CDMA or WCDMA modem.

Therefore, since the mobile Internet access unit can be configured by replacing various modems so as to match with a corresponding service in any areas, the mobile Internet access point can provide the best service in that area.

In an embodiment of the present invention, as shown in FIG. 1, the mobile Internet access point is implemented to include a plurality of mobile Internet access units 110.

The wireless LAN access unit 120 communicates with a wireless LAN terminal 200. The wireless LAN access unit 120 allows for the access of at least one or more wireless LAN terminals. The wireless LAN access unit 120 allocates private IPs to the wireless LAN terminals connected thereto and manages them, respectively. On the other hand, the wireless LAN terminal 200 includes a wireless LAN module to be connected to a wireless LAN. For example, a laptop computer and a smart phone, as examples of the wireless LAN terminal 200, can be connected to a wireless LAN based on the Wi-FI standard.

The converting unit 130 converts wireless data, received via the wireless LAN access unit 120, into data following the protocol of the mobile Internet, which is called mobile Internet data. The converting unit 130 also converts mobile Internet data, received via the mobile Internet access unit 110, into data following the protocol of a wireless LAN, which is called wireless LAN data. For example, when the wireless LAN access unit 120 receives data from the wireless LAN terminal 200 and outputs it to the converting unit 130, the converting unit 130 performs the data conversion to meet the protocol of the mobile Internet and then transfers the converted data to the mobile Internet access unit 110. Likewise, when the mobile Internet access unit 110 receives data from the base station 300 of the mobile Internet and outputs it to the converting unit 130, the converting unit 130 performs the data conversion to meet the protocol of the wireless LAN and then transfers the converted data to the wireless LAN access unit 120, so that the wireless LAN access unit 120 transmits the data to the wireless LAN terminal 200.

The controller 140 controls a plurality of mobile Internet access units that are communicating with the base station 300. In an embodiment of the present invention, although the mobile Internet access point 100 is implemented to include two mobile Internet access units for the operation of two communication modes, it should be understood that the present invention is not limited to the embodiment. That is, the mobile Internet access point 100 can also be implemented to include three or more mobile Internet access units.

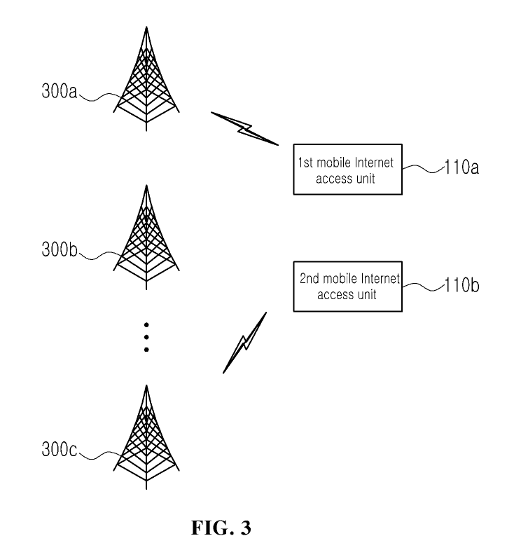

In the following description, the operations of the mobile Internet access point are explained in detail according to the communication modes with reference to FIGS. 2 and 3.

FIG. 2 is a view that describes communication between a base station and a mobile Internet access unit of a mobile Internet access point for a wireless LAN terminal, according to an embodiment of the present invention.

As shown in FIG. 2, the mobile Internet access point is operated in the first mode where the first mobile Internet access unit 110a scans base stations, receives the highest intensity signal and communicates with the first base station 300a transmitting the highest intensity signal; and the second mobile Internet access unit 110b scans the remaining base stations except for the first base station 300a, receives the highest intensity signal and communicates with the second base station 300b transmitting the highest intensity signal. That is, the first and second mobile Internet access units 110a and 110b communicate with the first and second base stations 300a and 300b, respectively, in the first mode.

Therefore, although the mobile Internet access point 100 receives and transmits a great deal of data, once, from and to the wireless LAN terminal 200 during the first mode, it can reduce the amount of load to the base stations.

For example, if the mobile Internet access point 100 receives two FTP sessions from the wireless LAN terminal 200, the mobile Internet access unit 100 distributes the data to the first and second mobile Internet access units 110a and 100b, so that they transmit the data to the first and second base stations 300a and 300b, respectively. Therefore, although the mobile Internet access point 100 receives a large amount of data, it can distribute and transmit the data to the base stations, thereby reducing the amount of load to the base stations.

In addition, if one of the first and second mobile Internet access units 110a and 110b does not work, another can continue performing communication, so that the mobile Internet access point can provide the services to the wireless LAN terminal 200 without interruption.

FIG. 3 is a view that describes communication between a base station and a mobile Internet access unit of a mobile Internet access point for a wireless LAN terminal, according to another embodiment of the present invention.

As shown in FIG. 3, the mobile Internet access point is operated in the second mode according to a user's settings regarding connection among the first and second mobile Internet access units 110a and 11b and the base stations. For example, the user sets the mobile Internet access point in such a way that: the first mobile Internet access unit 110a can be connected to a base station transmitting the highest intensity signal, for example, the first base station 300a; and the second mobile Internet access unit 110b can be connected to a base station closest thereto, for example, the third base station 300c.

The controller 140 sets the mode according to a user's settings. That is, the user can set his/her mode setting in the controller 140: he/she accesses the mobile Internet access point 100 via his/her wireless LAN terminal 200 and sets the mode via a mode setting webpage provided by the controller 140, using Internet Explorer, for example.

If a base station communicating with one of the mobile Internet access units transmits a level of signal less than a preset value thereto, the controller 140 controls the mobile Internet access unit to disconnect communication with the base station and to scan other base stations in order to perform communication with the corresponding base station again. For example, if the first mobile Internet access unit 110a receives a level of signal, less than a preset value, from the first base station 300a while they are communicating with each other, the controller 140 disconnects the current communication therebetween and scans the remaining base stations except for the first base station 300a so that the first mobile Internet access unit 110a can be connected to the scanned base station transmitting the highest intensity signal.

Therefore, although one of the mobile Internet access units is not smoothly communicating with a corresponding base station and accordingly is disconnected therewith, the remaining mobile Internet access units can continue communicating with other base stations, so that the mobile Internet terminal can receive services from the base station via the mobile Internet access point without interruption.

Although the embodiment of the present invention has explained two modes, it should be understood that the present invention is not limited to the embodiment. For example, the embodiment may be modified in such a way that the first and second mobile Internet access units 110a and 110b can be simultaneously communicated with a particular base station transmitting the highest intensity signal.

As described above, since the mobile Internet access point according to the present invention includes a plurality of mobile Internet access units that can be communicated with base stations, respectively, although one of the mobile Internet access units does not work, the remaining mobile Internet access units can continue communicating with the base stations. Therefore, the wireless LAN terminal can stably receive services from the base station via the remaining mobile Internet access units without interruption.

Since the mode of communication between a plurality of mobile Internet access units and the base stations can be set via the controller, the wireless LAN terminal can stably use a wireless LAN via the mobile Internet.

If the mobile Internet access point ascertains that one of the plurality of mobile Internet access units receives a level of signal less than a preset value from a base station connected thereto, it disconnects the communication therebetween, scans the other base stations and connects the mobile Internet access unit to the scanned base station transmitting the highest intensity signal again. While the mobile Internet access point is being scanned the other base stations when one mobile Internet access unit is not connected to a base station, the remaining mobile Internet access units communicate with the base stations, respectively, thereby providing high quality services to the mobile Internet terminal, without interruption.

Since the plurality of mobile Internet access units of the mobile Internet access point can be replaced with other types of mobile Internet access units to meet the communication protocol

However, wireless LAN terminals require a wireless router that can access a wireless LAN, so that it can be connected to the wired Internet via the wireless LAN. One Korean telecommunication company has allowed smart phone users subscribing to their services to access a wireless LAN for free. However, the systems adapted to the wireless LAN can provide wireless service within a radius of a few tens of meters with respect to the wireless router. That is, the systems for the wireless LAN do not have a wider coverage area than those for the mobile communication network.

In Korean Patent Registration No. 10-0652336, entitled “MOBILE ACCESS POINT COOPERATING WITH WIRELESS LAN/MOBILE INTERNET AND METHOD FOR PROVIDING SERVICES USING THE SAME,” a wireless LAN terminal was disclosed that can access a mobile Internet and use the Internet therethrough.

While the access unit of the conventional wireless LAN terminal is communicating with the base station, the wireless LAN terminal is connected to the mobile Internet and uses corresponding services. If the signal becomes weak between the access unit and the base station, the wireless LAN terminal may be disconnected from the Internet or may experience a low service speed.

### SUMMARY OF THE INVENTION

The present invention solves the above problems, and provides that can be serviced in corresponding local areas, the mobile Internet access point can be connected to the mobile Internet, so that the mobile Internet terminals can access the Internet via the mobile Internet irrespective of local areas.

Although exemplary embodiments of the present invention have been described in detail hereinabove, it should be understood that many variations and modifications of the basic inventive concept herein described, which may appear to those skilled in the art, will still fall within the spirit and scope of the exemplary embodiments of the present invention as defined in the appended claims.

What is claimed is:

1. A mobile Internet access point for a wireless LAN terminal, comprising:
a plurality of mobile Internet access units that communicate with one or more base stations, respectively, and connected to a mobile Internet;
a wireless LAN access unit, connected to one or more wireless LAN terminals that can be connected to a wireless LAN, for managing one or more connected wireless LAN terminals; and
a converting unit for converting wireless data, received by the wireless LAN access unit, into mobile Internet data following the protocol of the mobile Internet and mobile Internet data, received via the plurality of mobile Internet access units, into wireless LAN data following the protocol of the wireless LAN.

2. The mobile Internet access point according to claim 1, wherein:
one of the plurality of mobile Internet access units scans the base stations and communicates with a base station transmitting the highest intensity signal; and
another of the plurality of mobile Internet access units communicates with one of the remaining base stations except for the base station that is communicating with the one mobile Internet access unit.

3. The mobile Internet access point according to claim 1, further comprising:
a controller for setting modes of communication between the plurality of mobile Internet access units and the base stations,
wherein the modes are to set connections between the plurality of mobile Internet access units and the base stations, respectively.

4. The mobile Internet access point according to claim 3, wherein the modes comprises:
a mode that is set by a user to communicate the plurality of mobile Internet access units with one or more base stations.

5. The mobile Internet access point according to claim 1, wherein the wireless LAN terminal comprises a Wi-Fi module.

6. The mobile Internet access point according to claim 1, wherein, if the one of the plurality of mobile Internet access units has a level of weak signal less than a preset value from the base station connected thereto, the mobile Internet access point scans the remaining base stations so that the mobile Internet access unit receiving the weak signal can be connected to a corresponding base station.

7. The mobile Internet access point according to claim 1, wherein the plurality of mobile Internet access units are one of the WiMAX, CDMA and WCDMA modems.
